(19) United States
(12) Patent Application Publication
(10) Pub. No.: US 2026/0145969 A1
(43) Pub. Date: May 28, 2026

(54) Water Skimmer Having a Variable Flow Control Device

(71) Applicant: J.W. Faircloth & Son, LLC, Hillsborough, NC (US)

(72) Inventors: Prasad M. Joshi, Raleigh, NC (US); Ryan A. Bailey, Raleigh, NC (US); Michael E. Laut, Raleigh, NC (US)

(21) Appl. No.: 19/363,845

(22) Filed: Oct. 21, 2025

Related U.S. Application Data
(60) Provisional application No. 63/712,716, filed on Oct. 28, 2024.

(51) Int. Cl. C02F 1/40; B01D 21/24; C02F 1/00

(52) U.S. Cl. CPC C02F 1/40; B01D 21/2444; B01D 2201/16; B01D 2201/64; C02F 2001/007; C02F 2201/005

(57) ABSTRACT

The present invention relates to a gravity fed water skimmer having a variable flow control device or valve that is manually adjustable to vary the flow of water from a body of water through a drain head that forms a part of the water skimmer to a discharge point.

### RELATED APPLICATION

This application claims priority to U.S. Provisional Patent Application Ser. No. 63/712,716 filed on Oct. 28, 2024, which is incorporated herein by reference in its entirety.

### FIELD OF THE INVENTION

The present invention relates to water skimmers, and more particularly to a water skimmer that is provided with a variable flow control device (adjustable orifice) for controlling the volume of water flow through the skimmer.

### BACKGROUND OF THE INVENTION

Skimmers are floating devices that de-water from the surface or upper level of a body of water and convey water to a discharge point. They are used in many applications that range from wastewater, stormwater, and sediment basins. For example, skimmers can be used to remove a top layer of water from a sediment basin, wastewater tank, pond, lagoon, etc., which is often the cleanest layer of water. Their general function is to maintain water quality by skimming off the top layer of water and allowing particles and suspended solids to settle to the bottom. In this regard, water skimmers often work in conjunction with other sediment control practices like baffles and flocculants to reduce total suspended solids in water.

For example, see U.S. Pat. No. 5,820,751 (the '751 patent) that discloses a water skimmer used to control sediment pollution. The disclosure in this patent is expressly incorporated hereby by reference. In the context of a sediment basin, water skimmers serve the purpose of dewatering from the surface of the water. This helps improve water quality and reduce the risk of contamination in downstream water sources. By dewatering from the surface, skimmers allow the sediment to settle more efficiently at the bottom of the basin. This enhances the effectiveness of the basin in controlling sediment and other pollutants before water is discharged or reused.

One of the problems or shortcomings with conventional skimmers is that many designs fail to address the need to vary and control the flow of water through the skimmer. This is important in many applications. Some skimmers rely on gravity to pull the water through the skimmer to a discharge point. Often these skimmers are provided with a fixed drain opening (i.e., the area of the drain opening is fixed and not variable) that is typically positioned slightly underneath the water level. Hence, for a particular position of the skimmer with respect to the water level, the flow through the skimmer is generally constant and cannot be materially changed. In the case of an application in a sediment basin, for example, there can be a need to vary the water flow from the body of water through the skimmer in order to control the water level in the basin within a certain range. For example, in many sediment basin applications, the influent into the basin will vary over time depending on the number and timing of rain events and the extent of such rain events. This means that with a constant flow skimmer that the water level can vary substantially over time and this can impact the effectiveness of the sediment basin to settle the sediment, and at the same time act as a buffer to inlet water flows.

In addition, some operators utilize skimmers in various applications where some applications are best suited for maintaining a relatively large flow through the skimmer, while other applications are best suited for a relatively low flow. Hence, with a skimmer that includes a fixed drain opening that cannot be varied, this makes it virtually impossible for the operator to use the same skimmer in many different applications that require different flow rates.

Therefore, the present invention aims to provide a skimmer that includes a variable flow control device or valve that can be manually adjusted to vary the water flow through the skimmer. This allows the flow through the skimmer to be adjusted from time-to-time to fit environmental conditions in and around the body of water and in the end, to control the water level of the body of water appropriately in terms of influent and effluent flows. Furthermore, the present invention will allow an operator to use the same skimmer in many different applications that require various flow rates for optimum performance.

### SUMMARY OF THE INVENTION

The present invention entails a gravity-fed water skimmer having a variable flow control device or valve that is manually adjustable to vary the flow of water from a body of water to a discharge point.

In one embodiment, the present invention entails a gravity-fed water skimmer for skimming water from a body of water that comprises:
a float;
a drain head connected to the float and supported thereby;
   the drain head including a housing and an inlet opening formed in the housing to permit flow from the body of the water into the drain head;
   a drain line operatively connected to the drain head and extending therefrom for directing water from the drain head;
   a variable flow control device or valve incorporated into the drain head for controlling the flow of water through the drain head and into the drain line;
   the variable flow control device or valve including a drain opening or orifice communicatively connected to a drain line and the slide plate having an opening (sometimes referred to as a slide opening) therein and mounted adjacent the drain opening and moveable back and forth across at least a portion of the drain opening so as to vary the effective cross-sectional area of the drain opening; and
   wherein the slide plate and opening therein are configured to vary the effective open area of the drain opening in response to sliding the slide plate and opening therein over the drain opening.

Other objects and advantages of the present invention will become apparent and obvious from a study of the following description and the accompanying drawings which are merely illustrative of the invention.

### BRIEF DESCRIPTION OF THE DRAWING

FIG. 1 is a perspective view of the water skimmer of the present invention.

FIG. 2 is a perspective view similar to FIG. 1 but showing the screen of the drain head in an open position.

FIG. 3 is a fragmentary perspective view showing the variable flow control device incorporated into the drain head.

FIG. 4 is a fragmentary perspective view of a portion of the water skimmer illustrating a drain opening formed in the drain head and a slide plate, both of which form a part of the variable flow control device.

FIG. 5 is a close-up view showing the slide plate and drain opening that form the variable flow control device incorporated into the drain head.

FIG. 6 is an enlarged view showing the indicia formed in the slide plate that serves as an indicator of the open area of the drain opening for various positions of the slide plate.

### DESCRIPTION OF EXEMPLARY EMBODIMENTS OF THE PRESENT INVENTION

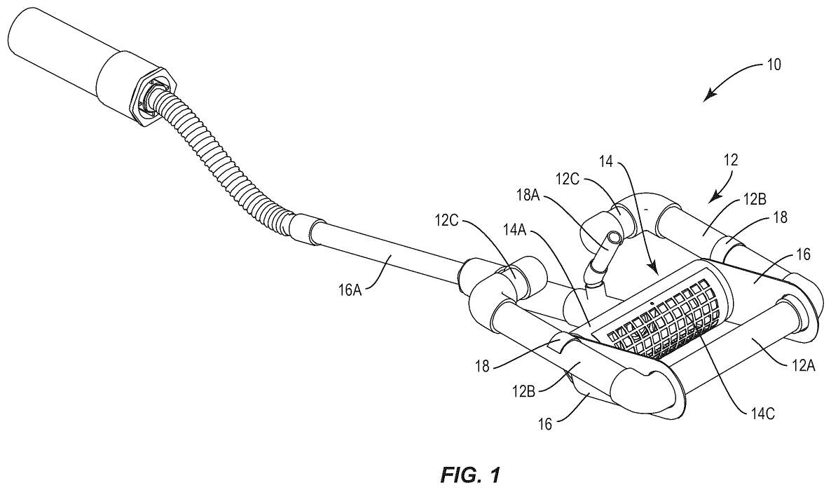

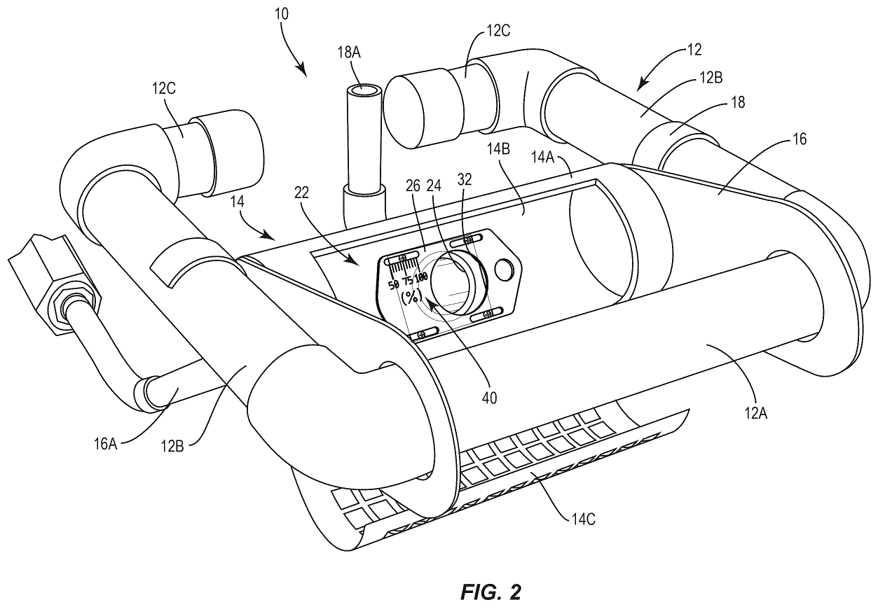

With further reference to the drawings, particularly FIGS. 1 and 2, the water skimmer of the present invention is shown therein and indicated generally by the numeral 10. Water skimmer 10 is of the gravity flow type in that the water skimmer is designed or configured to be disposed on the surface water in a position where gravity induces the flow of water from the body of water into and through the water skimmer. Water skimmer 10 is designed to skim water from the surface or near the surface of any body of water and to direct the skimmed water from the water skimmer to a point of discharge. As discussed below, water skimmer 10 is useful in many applications where it is desirable to skim water and debris, such as suspended solids, from the surface or near the surface of the water. For example, the water skimmer 10 can be employed in a sediment basin, a wastewater treatment application, such as in a flotation zone or as noted above in any application where there is a desire to skim water, debris, suspended solids, etc. from a body of water, or control the water level of a body of water held in a tank, basin or the like.

As seen in FIG. 1, the water skimmer 10 includes a float structure indicated generally by the numeral 12. Although the float structure 12 can vary in design, in the embodiment illustrated herein the float structure comprises a generally U-shaped configuration. See FIGS. 1 and 2. The U-shaped configuration includes a base segment 12A, a pair of arm segments 12B, and a pair of stub segments 12C. Float structure 10 can be constructed of various materials so long as the materials provide sufficient buoyancy to support the water skimmer 10 about the surface of the body of water. In the exemplary design shown in the drawings, the float structure is comprised of PVC piping.

Supported by the float structure 12 is a drain head 14 that is secured between the arm segments 12B of the float structure 12. Drain head 14 comprises a housing 14A that includes an internal chamber. The design and shape of the housing 14A can vary. In the exemplary design shown in the drawings, housing 14A assumes a generally cylindrical shape and includes a pair of end caps on opposite ends thereof.

An inlet opening 14B is formed in the side of housing 14A. See FIG. 2. As will be appreciated from subsequent portions of the disclosure, the inlet opening 14B enable water from the body of water supporting the water skimmer to enter the drain head 14. When in the operative position, inlet opening 14B is partially closed by a screen 14C. Screen 14C is moveably mounted to the housing 14A and can move from an operative closed position as shown in FIG. 1 to an open position that permits access to the interior of the housing 14A which is shown in FIG. 2.

Water skimmer 10 is provided with an elongated and in some cases a flexible drain line 16A. Drain line 16A is communicatively connected to the drain head 14 and functions to receive water from the drain head and to direct the water to a discharge point. Details of the drain line 16A are not dealt with herein in detail because the drain line is not per se material to the present invention. However, for a complete and unified understanding of a drain line and how a drain line communicates with the drain head 14 and the water skimmer 10, one is referred to the '751 patent which is expressly incorporated herein by reference. In any event, associated with the drain line 16A is an air vent 18A. Air vent 18A is open at the top and extends above the water level when the water skimmer 10 is employed. Hence, the air vent 18A is open at the top and assists in controlling the flow of water from the drain head 14 into and through the drain line 16A. Generally speaking, the air vent enables air to enter the drain line 16A and this generally prevents the drain line from siphoning water from the body of water through the drain head 14 into the drain line.

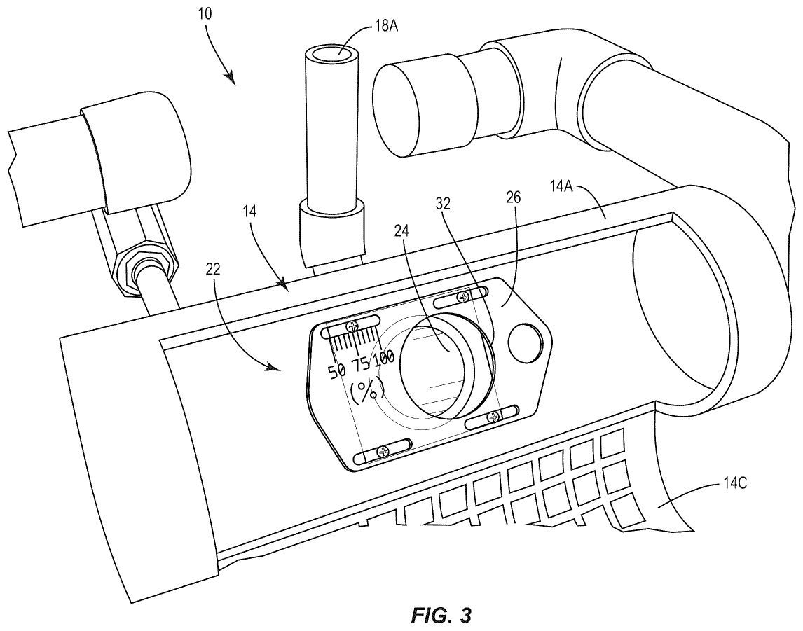

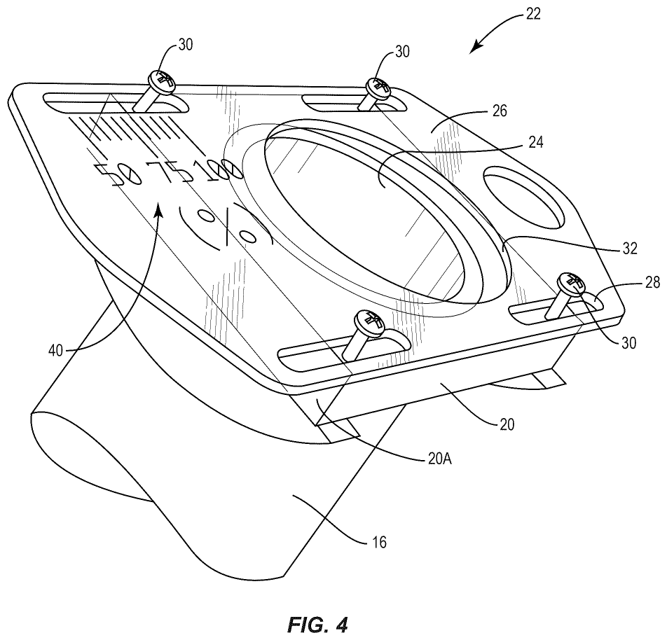

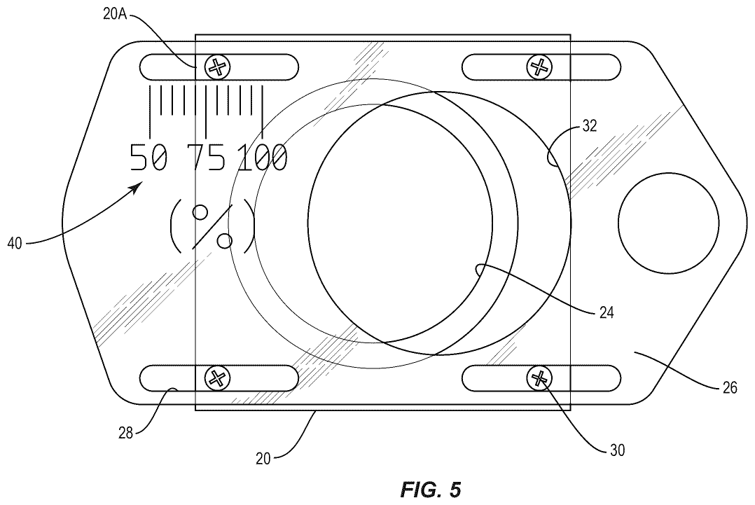

As noted above, the drain line 16A and how the drain line interconnects and communicates with the drain head 14 can vary. In the exemplary design shown in the drawings, the drain line 16A extends slightly into the drain head 14. See FIGS. 2 and 3. Note that disposed on the inlet end of the drain line is a mounting block 20 (FIG. 4) that is disposed inside the housing 14A of the drain head 14. Mounted on the mounting block 20 is a variable flow control device or valve indicated generally by the numeral 22. See FIGS. 2-4. Note that mounting block 20 includes an opening or orifice 24. See FIGS. 2-4. Opening 24 is communicatively connected to the drain line 16A. That is, water that enters the drain head 14 will be directed by gravity through opening 24 into the drain line 16A. The variable flow control device or valve 22 includes a slide plate 26 and the opening 24 just referred to also forms a part of the variable flow control device. Slide plate 26 is mounted to the mounting block 20 and overlies opening 24. A series of slots 28 are formed in the slide plate 26 and a series of pins or screws 30 extend from the mounting block 20 through the slots. See FIGS. 2-4. Hence, slide plate 26 can slide back and forth across opening 24. Side plate 26 also includes an opening 32 sometimes referred to as a slide opening. Openings 24 and 32 are round and in the embodiment illustrated, each includes a similar open area. It is appreciated that by sliding the slide plate 26 back and forth across opening 24, the effective open area of opening 24 can be varied. This will vary the flow of water from the drain head through the variable flow control device 22 into the drain line 16. As the slide plate 26 is moved from left to right, as viewed in FIGS. 2-4, it is seen that the open area of opening 24 is progressively decreased. Slots 28 and pins 30 can be particularly designed and placed to enable the slide plate 26 to vary the effective open area through which water flows from the drain head 14 into the drain line 16. As the slide plate 26 is moved from right to left, the open area of opening 24 is progressively increased. As seen in FIG. 5, for example, the slide plate 26 is positioned such that opening 24 is mostly open. By sliding the slide plate 26 further to the right closes opening 24 more.

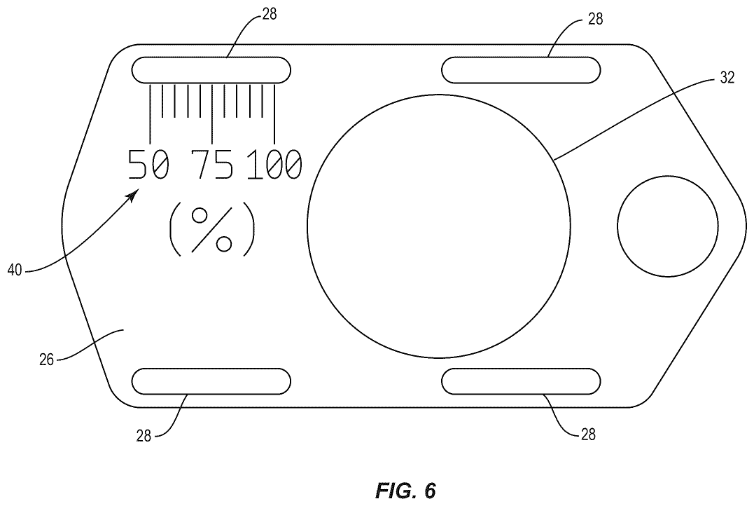

A scale (indicating percentage of open area) indicated generally by the numeral 40 (FIG. 6) is included on the slide plate 26 and serves as an indicator of the open area of the opening 24 for various positions of the slide plate. Slide plate 26 is transparent and includes percentage markings than range from 50% open to 100% open. As viewed in FIGS. 4 and 5, underlying the transparent guide plate 26 is a percentage indicating edge 20A that forms a part of the mounting block 20. That is, one can see the indicating edge 20A through the transparent guide plate 26. Thus, as the slide plate 26 is moved back and forth, it is seen that the percentage markings pass over the indicating edge 20A of the mounting block 20. Starting with the position shown in FIG. 5, it is seen that moving the slide plate 26 to the left further opens the effective area of opening 24. Moving this slide plate 26 to the right decreases the effective area of the opening 24. It is pointed out the percentage open markings 40 are not intended to precisely indicate the exact effective opening percentage at various locations of the slide plate 26. The percentage open markings 40 are to a significant degree relative markings that relate to the effective open area of the opening 24 at various positions of the slide plate 26.

There are many advantages to the present invention. First and foremost, the variable flow control device or valve 22 enables the water skimmer 10 to control the flow rate of water passing through the skimmer and can be adjusted based on any number of factors, such as the desired water level of the body of water supporting the skimmer 10. For example, the skimmer 10 may be employed in a sediment basin and over a period of time there may have been only a few rainfall events, and even then the rainfall events might not have been extensive. In this case, it may be desirable to set the variable flow control device 22 such that a relatively low flow of water passes through the skimmer 10. This can be helpful in maintaining the water level within a certain range. On the other hand, when there may have been many rainfall events and some of which may have been extensive. In this case, it may be important to increase the flow of water through the skimmer 10 in order to prevent overflow from the sediment basin or to simply maintain the water level within a desired range. Beyond that, the variable flow control device of the present invention enables the water skimmer to be used in many different types of applications that require different flow rates.

The present invention may, of course, be carried out in other specific ways than those herein set forth without departing from the scope and the essential characteristics of the invention. The present embodiments disclosed herein are therefore to be construed in all respects as illustrative and not restrictive and all changes coming within the meaning and equivalency range of the appended claims are intended to be embraced therein.

What is claimed is:

1. A gravity-fed water skimmer for skimming water from a body of water, comprising: a float;
a drain head connected to the float and supported thereby;
the drain head including a housing and an opening configured to permit water to enter the drain head;
a drain line operatively connected to the drain head and extending therefrom for directing water from the drain head;
a variable flow control device incorporated into the drain head for controlling the flow of water through the drain head and into the drain line;
the variable flow control device including a drain opening communicatively connected to the drain line and a slide plate having an opening formed therein and moveably mounted adjacent the drain opening and moveable back and forth across at least a portion of the drain opening; and
wherein the slide plate and opening therein are configured to vary the effective open area of the drain opening in response to sliding the slide plate back and forth over the drain opening.

2. The water skimmer of claim 1 wherein the drain opening is formed in the housing of the drain head, and wherein the slide plate is mounted inside the housing adjacent the drain opening.

3. The water skimmer of claim 1 wherein the drain opening and the opening in the slide plate are similarly shaped and include approximately the same open area.

4. The water skimmer of claim 1 wherein the slide plate includes markings configured to indicate the magnitude of the effective open area of the drain opening for various positions of the slide plate.

5. The water skimmer of claim 1 wherein the slide plate includes a series of elongated slots and wherein there is provided a series of fixing pins or screws that extend through the elongated slot and are configured to station or fix the slide plate at various positions with respect to the drain opening.

6. The gravity-fed water skimmer of claim 1 further including:
a. mounting block mounted to the housing of the drain head;
b. the mounting block including first and second sides;
c. wherein the drain line is communicatively connected to the first side of the mounting block; and
d. wherein the slide plate is mounted to the second side of the mounting block and wherein the drain opening of the variable flow control device is formed in the mounting block and communicatively connected to the drain line.

7. A method of skimming water from a body of water comprising:
a. floating a drain head on the surface of the body of water;
b. feeding water by gravity from the body of water through a screened opening formed in a housing that forms a part of the drain head;
c. wherein the water enters the housing and is directed through a slide opening in a slide plate that is moveably mounted over an orifice formed in a mounting block secured to a wall structure that forms a part of the housing of the drain head;
d. directing the water through the slide opening and into the orifice formed in the mounting block and from the orifice through the mounting block;
e. directing the water from the mounting block into an inlet of a drain line secured to the mounting block where the drain line extends from the mounting block through the body of water; and
f. adjusting the flow of water from the drain head through the drain line by sliding the slide plate and slide opening back and forth over the orifice on the mounting block to vary the effective area of the orifice as the slide plate is moved back and forth over the orifice such that the slide plate is effective to vary the open area of the orifice.

8. The method of claim 7 wherein the slide plate includes a series of elongated slots and wherein there is provided a series of fixing pins or screws that extend through the elongated slots and into the mounting block and where the series of fixing pins or screws is configured to station or fix the slide plate at various positions with respect to the orifice formed in the mounting block.

9. The method of claim 7 wherein the slide opening and the orifice have the same diameter and circumference such that when the slide opening squarely overlies the orifice, the orifice is completely open to allow water to flow through the slide opening into the orifice and from there through the mounting block into the drain line.
